(19) United States
(12) Patent Application Publication
(10) Pub. No.: US 2026/0336699 A1
(43) Pub. Date: Oct. 29, 2026

(54) Vehicle Behavior Estimation Method, Vehicle Behavior Detection Apparatus, and Steering System

(71) Applicant: Hitachi Astemo, Ltd., Hitachinaka-shi, Ibaraki (JP)

(72) Inventors: Kyohei FUKUSHI, Hitachinaka-shi, Ibaraki (JP); Yusuke AMMA, Hitachinaka-shi, Ibaraki (JP); Norio KIKUCHI, Hitachinaka-shi, Ibaraki (JP)

(21) Appl. No.: 19/107,778

(22) PCT Filed: Aug. 21, 2023
(86) PCT No.: PCT/JP2023/029919

§ 371 Date: Feb. 28, 2025

(30) Foreign Application Priority Data
Nov. 1, 2022 (JP) 2022-175532

(51) Int. Cl. B62D 15/02; B62D 6/00

(52) U.S. Cl. CPC B62D 15/029; B62D 6/00

(57) ABSTRACT

A vehicle behavior estimation method, a vehicle behavior detection apparatus, and a steering system of the present invention, in one aspect, provides a vehicle including a motor that applies steering torque to road wheels of the vehicle via a movable member, in which a normative running state of the vehicle calculated from steering operation information of the driver is compared with an actual running state of the vehicle to output a first deviation, a normative axial force generated in the movable member and calculated from the running speed of the vehicle and from the steering angle of the road wheels is compared with the estimated axial force generated in the movable member and calculated from the current value of the motor to output a second deviation, and the behavior of the vehicle is estimated by comparing the first deviation with the second deviation. This makes it possible to improve accuracy in the vehicle behavior detection.

### TECHNICAL FIELD

The present invention relates to a vehicle behavior estimation method, a vehicle behavior detection apparatus, and a steering system.

### BACKGROUND ART

The vehicle turning behavior control device of Patent Document 1 calculates a target yaw rate based on the steering angle and the vehicle speed, determines that the vehicle is in an understeer state if the actual yaw rate input from the yaw rate sensor is less than the target yaw rate, and determines that the vehicle is in an oversteer state if the actual yaw rate is greater than the target yaw rate.

### REFERENCE DOCUMENT LIST

### Patent Document

Patent Document 1: JP 2011-093489 A

### SUMMARY OF THE INVENTION

### Problem to be Solved by the Invention

A yaw rate deviation is the deviation between the normative yaw rate that is calculated from the steering angle of the road wheels, the vehicle speed, etc., and the yaw rate that is actually occurring in a vehicle. If vehicle behavior is understeering or oversteering, and this behavior is detected based on the yaw rate deviation, the yaw rate deviation also occurs due to disturbances such as an uneven road surface on which the vehicle is running.

Thus, it is problematic in that the vehicle behavior detection based on the yaw rate deviation becomes less accurate due to disturbances.

The present invention has been made in view of the conventional circumstances, and an object of the present invention is to provide a vehicle behavior estimation method, a vehicle behavior detection apparatus, and a steering system that can improve accuracy in the vehicle behavior detection.

### Means for Solving the Problem

A vehicle behavior estimation method, a vehicle behavior detection apparatus, and a steering system according to the present invention, in one aspect, calculates a normative running state of a vehicle from steering operation information of a driver of the vehicle, compares the normative running state with a running state that actually occurs in the vehicle and outputs a first deviation, calculates a normative axial force generated in a movable member from a first physical amount related to a running speed of the vehicle and a second physical amount related to a steering angle of the road wheels, calculates an estimated axial force generated in the movable member from a third physical amount related to a current value of a motor, compares the normative axial force with the estimated axial force and outputs a second deviation, and estimates the behavior of the vehicle by comparing the first deviation with the second deviation.

### EFFECTS OF THE INVENTION

According to the present invention, it is possible to improve accuracy of vehicle behavior detection.

### BRIEF DESCRIPTION OF THE DRAWINGS

FIG. 1 is a schematic diagram of a vehicle including a steer-by-wire steering system.

FIG. 2 is a functional block diagram showing a procedure for estimating a vehicle behavior.

FIG. 3 is a time chart exemplifying a change in the yaw rate deviation and axial force deviation in an uneven region on a road surface.

### MODE FOR CARRYING OUT THE INVENTION

Hereinafter, an embodiment of a vehicle behavior estimation method, a vehicle behavior detection apparatus, and a steering system according to the present invention will be described based on the drawings.

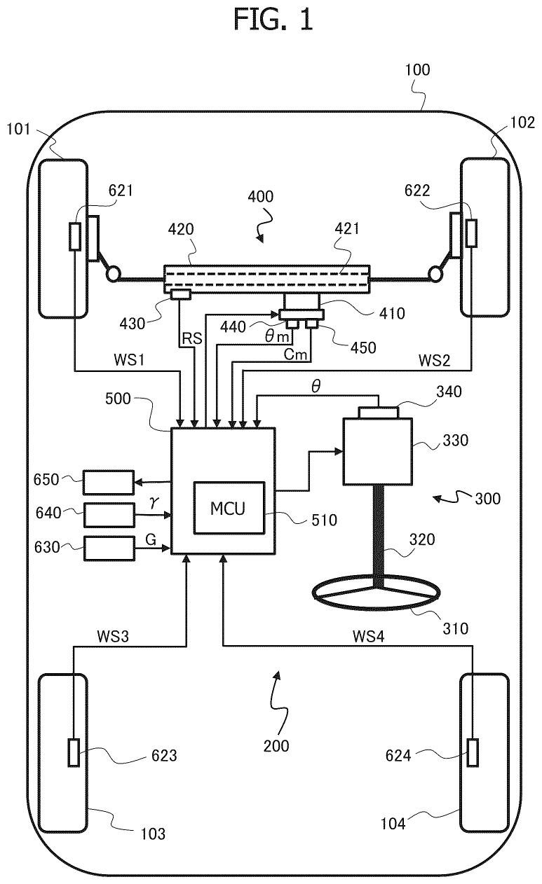

FIG. 1 is a schematic diagram showing an example of a vehicle 100 in which a steer-by-wire steering system 200 is mounted.

Vehicle 100 is a four-wheeled automobile having a pair of road wheels, one of which is a right front road wheel 101 and the other of which is a left front road wheel 102, and a pair of road wheels, one of which is a right rear road wheel 103 and the other of which is a left rear road wheel 104.

Steering system 200 includes a steering operation input apparatus 300 to which the steering operation of the driver of vehicle 100 is input via a steering wheel 310, a steering apparatus 400 having a steering motor 410 that applies steering torque to the road wheels (specifically, front road wheels 101 and 102) of vehicle 100, and a steering control apparatus 500.

Here, operation input apparatus 300 and steering apparatus 400 are mechanically separated from each other.

Steering operation input apparatus 300 includes steering wheel 310, a steering shaft 320, a reaction force motor 330, and an operation angle sensor 340.

Steering wheel 310 is a steering operation input member that is operated by the driver of vehicle 100.

Reaction force motor 330 is an actuator to apply a simulated steering reaction force torque to steering wheel 310.

Operation angle sensor 340 is a sensor that detects an operation angle θ [deg] of steering wheel 310.

Steering apparatus 400 includes a steering mechanism 420.

Steering mechanism 420 changes steering angle of front road wheels 101 and 102 by converting the rotational motion of steering motor 410 into a linear motion of a rack bar 421, based on a rack-and-pinion mechanism.

That is, steering motor 410 applies steering torque to front road wheels 101 and 102 via rack bar 421, which is a movable member.

In addition, steering apparatus 400 includes a rack stroke sensor 430 for detecting a rack stroke RS [mm], which is the stroke amount of rack bar 421 that correlates with the steering angle of front road wheels 101 and 102, a motor rotation angle sensor 440 for detecting a rotation angle θm [deg] of steering motor 410, and a motor current sensor 450 for detecting a current value Cm [Arms] of steering motor 410.

Steering control apparatus 500 is an electronic control device including a MCU (Micro Controller Unit) 510, and controls the operation of steering system 200 by controlling reaction force motor 330 and steering motor 410, which are the actuators included in steering system 200.

In other words, MCU 510 may be referred to as a microcomputer, a processor, a processing device, an arithmetic device, or the like.

MCU 510 executes arithmetic processing with various kinds of signals acquired from the outside to calculate a control signal for reaction force motor 330 and a control signal for steering motor 410, and outputs these calculated control signals.

Here, steering control apparatus 500 may include a pre-driver, an inverter, etc., for controlling the current flowing through reaction force motor 330 and the current flowing through steering motor 410.

Separately from steering control apparatus 500, vehicle 100 may include a system including a drive circuit including a pre-driver, an inverter, etc.

Vehicle 100 also includes wheel speed sensors 621 to 624 for detecting wheel speeds WS1 to WS4, which are the rotational speeds of road wheels 101 to 104, a longitudinal acceleration sensor 630 for detecting longitudinal acceleration G of vehicle 100, and a yaw rate sensor 640 for detecting a yaw rate γ [deg/s] that occurs in vehicle 100.

MCU 510 of steering control apparatus 500 acquires output signals of operation angle sensor 340, rack stroke sensor 430, motor rotation angle sensor 440, motor current sensor 450, wheel speed sensors 621 to 624, longitudinal acceleration sensor 630, and yaw rate sensor 640.

Here, the control details of steering system 200 (specifically, reaction force motor 330 and steering motor 410) by MCU 510 of steering control apparatus 500 will be briefly described.

MCU 510 calculates a target rack stroke RStg (in other words, a target value of the steering angle), which is a target value of the stroke amount of rack bar 421, based on information about operation angle θ of steering wheel 310.

MCU 510 then calculates a control signal of steering motor 410 based on the deviation between actual rack stroke RS detected by rack stroke sensor 430 and target rack stroke RStg, in other words, based on the control error of the steering angle, and outputs the calculated control signal to the drive circuit of steering motor 410.

Although actual rack stroke RS is detected by using rack stroke sensor 430 in this embodiment, actual rack stroke RS, which is the stroke amount of rack bar 421, may also be calculated from a motor rotation angle θm, which is detected by motor rotation angle sensor 440, etc.

Actual rack stroke RS may also be calculated using the detector that is provided on the pinion gear and that detects the rotation angle of the pinion shaft.

In addition, MCU 510 calculates a reaction force torque command value TRtg, which is the target value of a reaction force torque TR, based on vehicle speed VS [km/h] calculated from wheel speeds WS1 to WS4 and the information about operation angle θ of steering wheel 310.

MCU 510 can calculate vehicle speed VS by acquiring the signals of wheel speeds WS1 to WS4 from wheel speed sensors 621 to 624. MCU 510 may acquire information about vehicle speed VS, which has been calculated by another electronic control device based on the signals of wheel speeds WS1 to WS4 via an in-vehicle network.

Next, MCU 510 outputs a control signal based on reaction force torque command value TRtg to the drive circuit of reaction force motor 330.

In this way, MCU 510 controls the operation of steering system 200 by controlling the steering torque applied to front road wheels 101 and 102 and by controlling reaction force torque applied to steering wheel 310.

In addition, MCU 510 has a function of estimating the vehicle behavior according to a predetermined procedure and providing a vehicle behavior notification for notifying the driver of vehicle 100 of the estimated vehicle behavior.

That is, MCU 510 is a control unit that executes the vehicle behavior estimation method, and constitutes the vehicle behavior detection apparatus.

Here, the vehicle behavior is understeer (U/S) or oversteer (O/S), which is the turning behavior of vehicle 100.

It is difficult for the driver to recognize understeer or oversteer, because the steering force of steering wheel 310 is unchanged in the steer-by-wire steering system 200 even if vehicle 100 is understeering or oversteering.

Thus, MCU 510 estimates whether or not vehicle 100 is understeering or oversteering, and warns the driver if vehicle 100 is understeering or oversteering so that the driver is encouraged to take measures such as performing corrective steering.

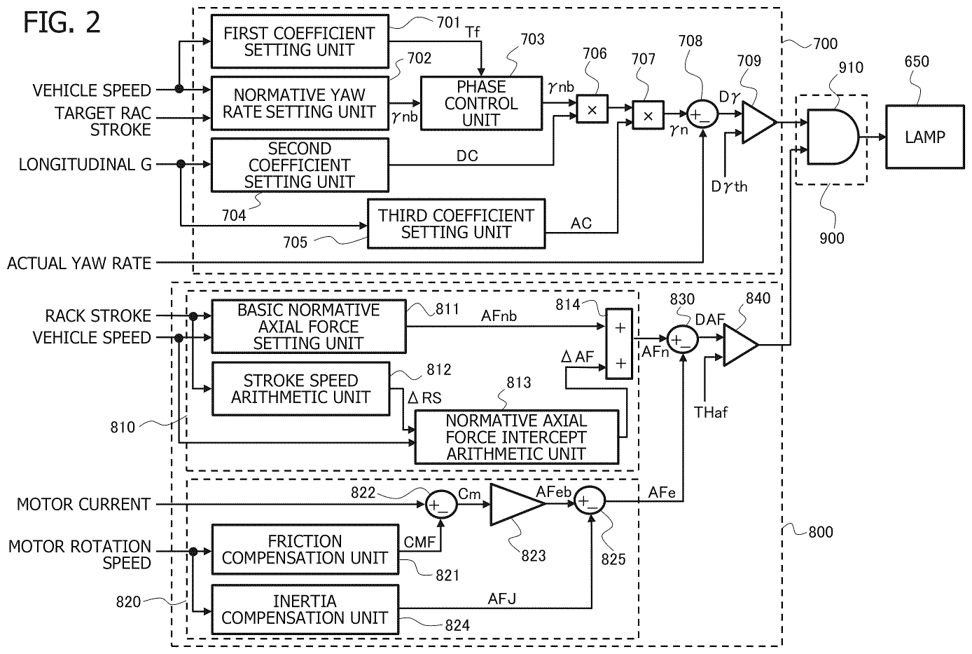

FIG. 2 is a functional block diagram showing a procedure for estimating the vehicle behavior in MCU 510.

The functional block diagram of FIG. 2 is grouped broadly into a first block 700 for outputting a yaw rate deviation Dγ [deg/s] as the first deviation, a second block 800 for outputting an axial force deviation DAF [kN] as the second deviation, and a third block 900 for comparing the output of first block 700 with the output of second block 800 and outputting an understeer or oversteer detection signal as the control signal that turns ON and OFF the vehicle behavior notification.

Here, first block 700 for calculating yaw rate deviation Dγ calculates yaw rate deviation Dγ, which is the deviation between a normative yaw rate γn and an actual yaw rate γa, and compares yaw rate deviation Dγ with a threshold Dγth so as to output a binary signal indicating whether or not vehicle 100 is understeering or oversteering.

On the other hand, second block 800 for calculating axial force deviation DAF calculates axial force deviation DAF [kN], which is the deviation between a normative axial force AFn [kN] and an estimated axial force AFe [kN] of rack bar 421, and compares axial force deviation DAF with a threshold THaf so as to output a binary signal indicating whether or not a disturbance affecting yaw rate deviation Dγ has occurred.

A disturbance that affects yaw rate deviation Dγ is, for example, the state of the road surface on which vehicle 100 is running, and more specifically, an uneven road surface.

Third block 900 performs a logical operation on the binary signal output by first block 700 and the binary signal output by second block 800 so as to output a binary signal indicating whether or not understeering or oversteering has occurred.

The detection of understeering or oversteering based on yaw rate deviation Dγ in first block 700 may result in erroneous detection if yaw rate deviation Dγ occurs due to a disturbance such as an uneven road surface.

Thus, third block 900 compares the detection result of understeering or oversteering in first block 700 with the detection result of disturbance in second block 800, and performs the final detection of understeering or oversteering so as to prevent erroneous detection due to a disturbance.

The detailed configuration of each of first block 700, second block 800, and third block 900 will be described below.

First block 700 has a first coefficient setting unit 701, a normative yaw rate setting unit 702, a phase control unit 703, a second coefficient setting unit 704, a third coefficient setting unit 705, a first multiplication unit 706, a second multiplication unit 707, a deviation arithmetic unit 708, and a comparison unit 709.

First coefficient setting unit 701 acquires a signal of vehicle speed VS, and based on vehicle speed VS, sets a time coefficient Tf, which is the characteristic value of the response delay of the vehicle behavior with respect to steering.

Normative yaw rate setting unit 702 acquires the signal of vehicle speed VS and a signal of target rack stroke RStg (in other words, the target steering angle) as the steering operation information, and based on them, calculates a basic normative yaw rate γnb, which is the basic value of normative yaw rate γn.

In other words, normative yaw rate setting unit 702 calculates basic normative yaw rate γnb as the normative running state of vehicle 100 from the steering operation information and the first physical amount related to the running speed of vehicle 100.

Normative yaw rate setting unit 702 may calculate basic normative yaw rate γnb based on vehicle speed VS and operation angle θ of steering wheel 310 as the steering operation information.

Phase control unit 703 acquires the signal of time coefficient Tf that is set by first coefficient setting unit 701 and the signal of basic normative yaw rate yγb that is calculated by normative yaw rate setting unit 702, and delays the phase of basic normative yaw rate γnb in accordance with time coefficient Tf.

Second coefficient setting unit 704 acquires a signal of a longitudinal acceleration [m/s²] of vehicle 100 that is detected by longitudinal acceleration sensor 630, and sets a change coefficient DC in accordance with the change characteristics of yaw rate y when vehicle 100 decelerates.

In addition, third coefficient setting unit 705 acquires a signal of longitudinal acceleration [m/s²] of vehicle 100 that is detected by longitudinal acceleration sensor 630, and sets a change coefficient AC in accordance with the change characteristics of yaw rate γ when vehicle 100 accelerates.

Then, first multiplication unit 706 acquires the signal of basic normative yaw rate γnb after the phase control, which is output by phase control unit 703, and change coefficient DC during deceleration, which is set by second coefficient setting unit 704. First multiplication unit 706 then multiplies basic normative yaw rate γnb by change coefficient DC during deceleration, and outputs the multiplication result as basic normative yaw rate γnb corrected during deceleration.

Furthermore, second multiplication unit 707 acquires the signal of basic normative yaw rate γnb corrected during deceleration, which is output by first multiplication unit 706, and change coefficient AC during acceleration, which is set by third coefficient setting unit 705. Second multiplication unit 707 then multiplies basic normative yaw rate γnb corrected during deceleration by change coefficient AC during acceleration, and outputs the multiplication result as normative yaw rate γyn.

Deviation arithmetic unit 708 acquires the signal of normative yaw rate γn, which is output by second multiplication unit 707, and the signal of actual yaw rate γac, which is detected by yaw rate sensor 640. Deviation arithmetic unit 708 then outputs the result of subtracting actual yaw rate γac from normative yaw rate γn as a signal of yaw rate deviation Dγ (Dγ=γn−γac).

Here, normative yaw rate yn is the normative running state that is calculated based on the steering operation information, and actual yaw rate γac that is detected by yaw rate sensor 640 is the running state that actually occurs in vehicle 100.

Therefore, deviation arithmetic unit 708 is a functional unit that compares the normative running state with the actual running state and outputs the first deviation.

Comparison unit 709 acquires the signal of yaw rate deviation Dγ calculated by deviation arithmetic unit 708 and the signal of threshold Dγth, and compares yaw rate deviation Dγ with threshold Dγth so as to output a binary signal indicating whether or not the vehicle is in the state of understeering or oversteering.

Here, the state in which the output signal of comparison unit 709 is 1 (High) indicates that understeering or oversteering has been detected.

On the other hand, the state in which the output signal of comparison unit 709 is 0 (Low) indicates that understeering or oversteering has not been detected, in other words, the vehicle is in the state of natural steering in which normative yaw rate γn and actual yaw rate γac are close to each other.

Yaw rate deviation Dγ is calculated as a positive or negative value, and a positive first threshold Dγth1 and a negative second threshold Dγth2 are also set for threshold Dγth.

Then, comparison unit 709 sets the output signal to 0 (Low) if yaw rate deviation Dγ is within the region between first threshold Dγth1 and second threshold Dγth2 (Dγth1≥Dγ≥Dγth2).

In addition, comparison unit 709 sets the output signal to 1 (High) if yaw rate deviation Dγ is greater than first threshold Dγth1 (Dγth1<Dγ), and also sets the output signal to 1(High) if yaw rate deviation Dγ is less than second threshold Dγth2 (Dγth2>Dγ).

In other words, comparison unit 709 sets the output signal to 1 (High) when the absolute value of yaw rate deviation Dγ is greater than a positive threshold.

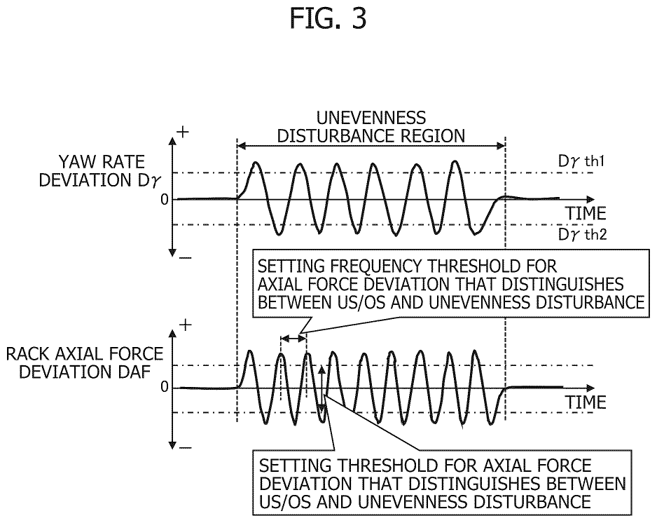

The upper part of FIG. 3 exemplifies the correlation between yaw rate deviation Dγ and thresholds Dγth1, Dγth2.

Yaw rate deviation Dγ in FIG. 3 is in a periodically varying state due to the effects of an uneven road surface, and periodically repeats the state in which yaw rate deviation Dγ is greater than first threshold Dγth1, the state in which yaw rate deviation Dγ is within the region between first threshold Dγth1 and second threshold Dγth2, and the state in which yaw rate deviation Dγ is less than second threshold Dγth2.

At this time, the output signal of comparison unit 709 alternates between 1 (High) and 0 (Low).

As described above, first block 700 calculates yaw rate deviation Dγ by comparing normative yaw rate γn, which is calculated from the vehicle speed and the rack stroke as the steering operation information, with the yaw rate that actually occurs in vehicle 100, and determines whether or not vehicle 100 is understeer or oversteer based on yaw rate deviation Dγ.

On the other hand, second block 800 has a normative axial force calculation block 810, an estimated axial force calculation block 820, a deviation arithmetic unit 830, and a comparison unit 840.

Normative axial force calculation block 810 has a basic normative axial force setting unit 811, a rack stroke speed arithmetic unit 812, a normative axial force intercept arithmetic unit 813, and an addition unit 814.

Basic normative axial force setting unit 811 acquires a signal of rack stroke RS and a signal of vehicle speed VS, and based on these signals, calculates a basic normative axial force AFnb, which is a basic value of normative axial force AFn generated in rack bar 421.

Rack stroke speed arithmetic unit 812 calculates a rack stroke speed ΔRS [mm/s], which is the amount of change of the rack stroke per unit time, by taking the differential of the signal of rack stroke RS.

Normative axial force intercept arithmetic unit 813 acquires a signal of rack stroke speed ARS and a signal of vehicle speed VS, and calculates an intercept AAF as a correction value for correcting basic normative axial force AFnb.

Then, addition unit 814 acquires a signal of basic normative axial force AFnb and a signal of intercept AAF, adds intercept AAF to basic normative axial force AFnb, and outputs the addition result as the final normative axial force AFn (AFn=AFnb+ΔAF).

In this way, normative axial force calculation block 810 calculates normative axial force AFn generated in rack bar 421 from the first physical amount related to the running speed of vehicle 100 and the second physical amount related to the steering angle of front road wheels 101 and 102.

Estimated axial force calculation block 820 has a friction compensation unit 821, a friction compensation subtraction unit 822, an axial force conversion unit 823, a motor inertia compensation unit 824, and an estimated axial force correction unit 825.

Friction compensation unit 821 acquires a signal of a motor rotation speed MRS [rpm] of steering motor 410, and calculates a current value CMF [Arms] for the mechanical friction based on motor rotation speed MRS.

Motor rotation speed MRS is calculated based on rotation angle θm [deg] of steering motor 410 that is detected by motor rotation angle sensor 440.

Friction compensation subtraction unit 822 acquires a signal of a motor current value Cm that is detected by motor current sensor 450 and a signal of current value CMF for the mechanical friction that is calculated by friction compensation unit 821, subtracts current value CMF for the mechanical friction from motor current value Cm, and outputs the subtraction result as motor current value Cm corrected for the mechanical friction.

Axial force conversion unit 823 acquires the signal of motor current value Cm that is output by friction compensation subtraction unit 822, and based on the acquired motor current value Cm, calculates a basic estimated axial force AFeb that is estimated to be generated in rack bar 421.

A conversion characteristic for calculating basic estimated axial force AFeb from motor current value Cm is determined, for example, from the rated torque, rated current, and speed reduction ratio of steering motor 410, and the stroke ratio (rack gain) in steering apparatus 400.

Motor inertia compensation unit 824 acquires a signal of motor rotation speed MRS of steering motor 410, and calculates an axial force AFJ [kN] for the inertia (moment of inertia) of steering motor 410 based on motor rotation speed MRS.

Estimated axial force correction unit 825 acquires the signal of basic estimated axial force AFeb that is calculated by axial force conversion unit 823 and axial force AFJ for the inertia that is calculated by motor inertia compensation unit 824, subtracts axial force AFJ for the inertia from basic estimated axial force AFeb, and outputs a final estimated axial force AFe (AFe=AFeb−AFJ).

As described above, estimated axial force calculation block 820 calculates estimated axial force AFe from the third physical amount related to motor current value Cm of steering motor 410 and the fourth physical amount related to motor rotation speed MRS of steering motor 410.

Then, deviation arithmetic unit 830 acquires the signal of normative axial force AFn that is output by addition unit 814 and the signal of estimated axial force AFe that is output by estimated axial force correction unit 825, and outputs the result of subtracting estimated axial force AFe from normative axial force AFn as a signal of axial force deviation DAF (DAF=AFn−AFe).

Comparison unit 840 acquires the signal of axial force deviation DAF calculated by deviation arithmetic unit 830 and a signal of threshold THaf, and based on a comparison between axial force deviation DAF and threshold THaf, outputs a binary signal indicating whether or not a disturbance such as an uneven road surface exists.

That is, comparison unit 840 provides a predetermined threshold for axial force deviation DAF and compares axial force deviation DAF with the predetermined threshold to distinguish whether or not a disturbance such as an uneven road surface exists.

FIG. 3 shows how yaw rate deviation Dγ and axial force deviation DAF vary when vehicle 100 is running on an uneven road surface.

Axial force deviation DAF periodically varies due to the effects of an uneven road surface, and yaw rate deviation Dγ also periodically varies due to the effects of an uneven road surface.

Specifically, when the road surface is uneven, vertical vibration of the vehicle body occurs, and yaw rate sensor 640 erroneously detects actual yaw rate γa, resulting in generation of yaw rate deviation Dγ.

First block 700 erroneously detects understeering or oversteering when yaw rate deviation Dγ varies beyond threshold Dγth (first threshold Dγth1, second threshold Dγth2). Therefore, in order to distinguish between the change in yaw rate deviation Dγ due to the effects of a disturbance and the change in yaw rate deviation Dγ due to understeering or oversteering, second block 800 determines whether or not a disturbance such as an uneven road surface exists based on a comparison between axial force deviation DAF and threshold THaf.

Here, if axial force deviation DAF and yaw rate deviation Dγ vary due to the effects of an uneven road surface, the varying frequency of axial force deviation DAF will be higher than the varying frequency of yaw rate deviation Dγ.

Thus, based on the varying frequency of yaw rate deviation Dγ, comparison unit 840 sets a frequency threshold THFaf for determining whether or not the varying frequency of axial force deviation DAF is higher than the varying frequency of yaw rate deviation Dγ.

If the frequency of axial force deviation DAF is higher than frequency threshold THFaf, in other words, if the frequency of axial force deviation DAF is higher than the frequency of yaw rate deviation Dγ, comparison unit 840 determines that axial force deviation DAF is varying due to an uneven road surface, and sets the output signal to 0 (Low).

That is, the output signal of comparison unit 840 being 0 (Low) indicates that an uneven road surface as a disturbance has been detected, in other words, yaw rate deviation Dγ is varying due to the effects of an uneven road surface.

On the other hand, if the frequency of axial force deviation DAF is equal to or less than frequency threshold THFaf, comparison unit 840 determines that no uneven road surface that would affect yaw rate deviation Dγ exists, and sets the output signal to 1 (High).

That is, the output signal of comparison unit 840 being 1 (High) indicates that an uneven road surface as a disturbance has not been detected, in other words, yaw rate deviation Dγ is varying due to the behavior of vehicle 100, i.e., understeering or oversteering, and is not affected by a disturbance.

Comparison unit 840 can set an amplitude threshold THAaf for determining the amplitude of axial force deviation DAF, set the output signal to 0 (Low) when the amplitude of axial force deviation DAF is beyond amplitude threshold THAaf, and set the output signal to 1 (High) when the amplitude of axial force deviation DAF is equal to or less than amplitude threshold THAaf.

That is, comparison unit 840 can determine whether or not an uneven road surface as a disturbance exists by comparing the amplitude of axial force deviation DAF with amplitude threshold THAaf.

Furthermore, comparison unit 840 can determine whether or not an uneven road surface as a disturbance exists by comparing the amplitude of axial force deviation DAF with amplitude threshold THAaf and by comparing the frequency of axial force deviation DAF with frequency threshold THFaf.

In this case, when the amplitude of axial force deviation DAF is beyond an amplitude threshold THAaf and the frequency of axial force deviation DAF is higher than frequency threshold THFaf, comparison unit 840 determines that axial force deviation DAF is varying due to an uneven road surface, and sets the output signal to 0 (Low).

When at least one of the conditions that the amplitude of axial force deviation DAF is equal to or less than amplitude threshold THAaf and that the frequency of axial force deviation DAF is equal to or less than frequency threshold THFaf is satisfied, comparison unit 840 determines that no uneven road surface exists, and sets the output signal to 1 (High). As described above, comparison unit 840 (second block 800) determines whether or not an uneven road surface as a disturbance exists based on the amplitude and/or frequency of axial force deviation DAF.

Third block 900 includes an AND operation unit 910.

AND operation unit 910 inputs the binary signal output by comparison unit 709 of first block 700 and the binary signal output by comparison unit 840 of second block 800, performs an AND operation on these signals, and outputs the binary signal as the operation result.

As described above, when understeering or oversteering has been detected based on yaw rate deviation Dγ, comparison unit 709 sets the output signal to 1 (High).

On the other hand, when comparison unit 840 determines that axial force deviation DAF is varying due to an uneven road surface (in other words, an uneven road surface as a disturbance has occurred) based on the comparison between axial force deviation DAF and threshold THaf, comparison unit 840 sets the output signal to 0 (Low).

At this time, the output signal of AND operation unit 910 becomes 0 (Low).

That is, even if comparison unit 709 has detected understeering or oversteering based on yaw rate deviation Dγ, if comparison unit 840 has detected an uneven road surface as a disturbance, the output signal of AND operation unit 910 becomes 0 (Low), indicating that understeering or oversteering has not been detected.

In other words, if comparison unit 840 has detected an uneven road surface as a disturbance, yaw rate deviation Dγ is deemed to be caused by a disturbance, and the detection result of understeering or oversteering is ultimately invalidated.

On the other hand, at the time comparison unit 709 has detected understeer or oversteer based on yaw rate deviation Dγ and the output signal of comparison unit 709 is 1 (High), the output signal of AND operation unit 910 becomes 1 (High) if comparison unit 840 has detected no uneven road surface and the output signal of comparison unit 840 is 1 (High).

That is, if understeering or oversteering has been detected based on yaw rate deviation Dγ and no uneven road surface has been detected, the output signal of AND operation unit 910 becomes 1 (High), indicating that understeering or oversteering has been detected.

In other words, when MCU 510 has detected no uneven road surface as a disturbance, MCU 510 determines whether or not the vehicle is understeering or oversteering based on yaw rate deviation Dγ.

Therefore, according to the vehicle behavior estimation method executed by MCU 510, accuracy in detecting understeering or oversteering is improved by preventing the erroneous detection of understeering or oversteering when yaw rate deviation Dγ has occurred due to the effects of an uneven road surface.

An output signal of AND operation unit 910 indicating whether or not understeering or oversteering has been detected (in other words, the understeering or oversteering detection signal) is given by MCU 510 to a warning lamp 650, which serves as the warning device, as the ON/OFF control signal.

Warning lamp 650 is lit when the output signal of AND operation unit 910 is 1 (High), and notifies the occurrence of understeering or oversteering to the driver of vehicle 100.

In other words, when MCU 510 estimates the occurrence of understeering or oversteering, MCU 510 activates warning lamp 650, which is the warning device included in vehicle 100.

When warning lamp 650 is lit, the driver of vehicle 100 may recognize the occurrence of understeering or oversteering, and may, for example, take action to deal with the understeering or oversteering.

Here, MCU 510 may prevent the erroneous detection of the occurrence of understeering or oversteering due to the effects of an uneven road surface, and thus, may convey accurate information regarding understeering or oversteering to the driver of vehicle 100.

The technical concepts described in the above embodiment may be used in any appropriate combination as long as they do not conflict with each other.

Although the present invention is specifically described above with reference to a preferred embodiment, it is apparent to one skilled in the art that variations of the embodiment can be made based on the basic technical concept and the teachings of the present invention.

For example, comparison unit 709 may detect oversteering and understeering as different vehicle behaviors by determining whether or not yaw rate deviation Dγ is above first threshold Dγth1, and further determining whether or not yaw rate deviation Dγ is below second threshold Dγth2.

Furthermore, comparison unit 840 may be configured to invalidate the detection result of oversteering or understeering if comparison unit 840 detects an uneven road surface as a disturbance.

Furthermore, if MCU 510 detects oversteering and understeering as different vehicle behaviors, MCU 510 may activate a warning device so that the driver can recognize oversteering and understeering as different vehicle behaviors.

Furthermore, if MCU 510 detects oversteering and understeering as different vehicle behaviors, MCU 510 may reflect the detection result in steering control and automatically perform corrective steering for oversteering or understeering.

The warning device for notifying of the occurrence of oversteering or understeering to the driver of vehicle 100 is not limited to warning lamp 650. For example, a warning buzzer, a liquid crystal display device, an audio guidance device, or the like may be used as the warning device.

In addition, steer-by-wire steering system 200 may include a backup mechanism that mechanically couples steering wheel 310 with front road wheels 101 and 102 by using a clutch or the like.

In addition, it is possible for steer-by-wire steering system 200 to individually include a first control device that outputs a control signal of steering motor 410 and a second control device that outputs a control signal of reaction force motor 330.

In such a steering system 200, either the first control device or the second control device may include the control unit that executes the vehicle behavior detection method, and may function as the vehicle behavior detection apparatus.

In addition, an electronic control device that does not have a function for controlling steering system 200 (in other words, reaction force motor 330 and steering motor 410) may include the control unit that executes the vehicle behavior detection method, and may function as the vehicle behavior detection apparatus.

### REFERENCE SYMBOL LIST

100 Vehicle
101, 102 Front road wheel
200 Steering system
300 Steering operation input apparatus
340 Operation angle sensor
400 Steering apparatus
410 Steering motor
421 Rack bar (Movable member)
430 Rack stroke sensor
500 Steering control apparatus (vehicle behavior detection apparatus)
510 Microcomputer (Control unit)

1. A vehicle behavior estimation method executed by a control unit mounted in a vehicle, the vehicle including a motor that applies steering torque to road wheels of the vehicle via a movable member,
the vehicle behavior estimation method executed by the control unit comprising:
calculating a normative running state of the vehicle from steering operation information of a driver of the vehicle;
comparing the normative running state with a running state that actually occurs in the vehicle and outputting a first deviation;
calculating a normative axial force generated in the movable member from a first physical amount related to a running speed of the vehicle and a second physical amount related to a steering angle of the road wheels;
calculating an estimated axial force generated in the movable member from a third physical amount related to a current value of the motor;
comparing the normative axial force with the estimated axial force and outputting a second deviation; and
estimating the behavior of the vehicle by comparing the first deviation with the second deviation.

2. The vehicle behavior estimation method according to claim 1, wherein the control unit calculates an estimated axial force generated in the movable member from the third physical amount and a fourth physical amount related to a rotation speed of the motor.

3. The vehicle behavior estimation method according to claim 1, wherein the control unit calculates a normative yaw rate as the normative running state from the steering operation information and the first physical amount, and compares the normative yaw rate with a yaw rate that actually occurs in the vehicle to output the first deviation.

4. The vehicle behavior estimation method according to claim 3, wherein the control unit provides a predetermined threshold for the second deviation.

5. The vehicle behavior estimation method according to claim 4, wherein the control unit determines whether or not the vehicle is understeering or oversteering based on the first deviation, and when the second deviation is beyond the predetermined threshold, determines that the first deviation is caused by a disturbance.

6. The vehicle behavior estimation method according to claim 4, wherein when the second deviation is not beyond the predetermined threshold, the control unit determines whether or not the vehicle is understeering or oversteering based on the first deviation.

7. A vehicle behavior detection apparatus having the control unit that executes the vehicle behavior estimation method according to claim 1, wherein the control unit activates a warning device provided in the vehicle in accordance with the estimated behavior of the vehicle.

8. A steering system comprising the vehicle behavior detection apparatus of claim 7, the movable member, and the motor.
